(19) United States
(12) Patent Application Publication
(10) Pub. No.: US 2020/0380505 A1
(43) Pub. Date: Dec. 3, 2020

(54) AUTO-PILOT TRANSACTIONS USING SMART CONTRACTS

(71) Applicant: INTUIT INC., Mountain View, CA (US)

(72) Inventors: Manish SHAH, Bangalore (IN); Aminish SHARMA, Bangalore (IN); Goutham KALLEPALLI, Bangalore (IN); Ashish Kumar MISHRA, Bangalore (IN)

(21) Appl. No.: 16/429,260

(22) Filed: Jun. 3, 2019

(51) Int. Cl. G06Q 20/38; H04L 9/32; H04L 9/06

(52) U.S. Cl. CPC G06Q 20/3829; H04L 9/3236; H04L 2209/38; H04L 9/0643; H04L 9/321

(57) ABSTRACT

Certain aspects of the present disclosure provide techniques for automatically guiding transaction performance. Embodiments include receiving first input from a first user identifying a term of a transaction between the first user and a second user. Embodiments include receiving second input from the second user confirming the term. Embodiments include deploying a smart contract that corresponds to the term on a hash chain. The smart contract may comprise a program that guides performance of the term, and the hash chain may be resistant to modification. Embodiments include receiving, from a management component of the hash chain, a notification that the smart contract has verified through a trusted authority that the term is satisfied.

### INTRODUCTION

Aspects of the present disclosure relate to techniques for using smart contracts to automatically guide performance of transactions. In particular, embodiments described herein involve using smart contracts stored on modification-resistant distributed systems to automatically guide performance of transactions according to user-defined contract terms.

### BACKGROUND

Many software applications provide services related to facilitating transactions, such as by allowing parties to sell and purchase goods and services, create and pay invoices, and the like. Parties generally advance through stages of transactions manually or as defined in a workflow, and must trust that the applications involved are reliable and secure. For instance, rules and variables (e.g., related to transaction terms such as shipment terms, payment terms, and penalties for breach) underlying an application workflow for a transaction are generally not visible to the parties, and could potentially be altered without knowledge of the parties. Some transactions, such as multi-party transactions, may have complicated terms, and parties may be unwilling to trust existing applications due to a lack of transparency with respect to implementation details.

Furthermore, existing applications generally require parties to independently verify that terms of a transaction have been met, such as by checking with a postal carrier to ensure that an item has been shipped or checking with a financial institution to ensure that funds have been transferred. Accordingly, there is a need for improved techniques for facilitating transactions using applications.

### BRIEF SUMMARY

Certain embodiments provide a method for automatically guiding transaction performance. The method generally includes: receiving first input from a first user identifying a term of a transaction between the first user and a second user; receiving second input from the second user confirming the term; deploying a smart contract that corresponds to the term on a hash chain, wherein: the smart contract comprises a program that guides performance of the term, and the hash chain is resistant to modification; and receiving, from a management component of the hash chain, a notification that the smart contract has verified through a trusted authority that the term is satisfied.

Other embodiments provide a non-transitory computer-readable medium comprising instructions that, when executed by one or more processors, cause the one or more processors to perform a method for automatically guiding transaction performance. The method generally includes: receiving first input from a first user identifying a term of a transaction between the first user and a second user; receiving second input from the second user confirming the term; deploying a smart contract that corresponds to the term on a hash chain, wherein: the smart contract comprises a program that guides performance of the term, and the hash chain is resistant to modification; and receiving, from a management component of the hash chain, a notification that the smart contract has verified through a trusted authority that the term is satisfied.

Other embodiments provide a system comprising one or more processors and a non-transitory computer-readable medium comprising instructions that, when executed by the one or more processors, cause the one or more processors to perform a method for automatically guiding transaction performance. The method generally includes: receiving first input from a first user identifying a term of a transaction between the first user and a second user; receiving second input from the second user confirming the term; deploying a smart contract that corresponds to the term on a hash chain, wherein: the smart contract comprises a program that guides performance of the term, and the hash chain is resistant to modification; and receiving, from a management component of the hash chain, a notification that the smart contract has verified through a trusted authority that the term is satisfied.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example computing environment in which embodiments of the present disclosure may be implemented.

FIG. 2 depicts an example hash chain on which embodiments of the present disclosure may be implemented.

FIG. 3 depicts an example user interface for automatically guiding performance of transactions.

FIG. 4 depicts example operations for automatically guiding performance of transactions.

FIGS. 5A and 5B depict example computer systems with which embodiments of the present disclosure may be implemented.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer readable mediums for utilizing smart contracts deployed on hash chains for automatically guiding performance of transactions.

Techniques described herein involve the use of smart contracts on distributed systems to automatically guide performance of transactions according to user-defined terms. Trust is a critically important factor in all transactions between parties, and the use of software applications to automate aspects of transactions often raises issues of transparency. For example, rules and variables maintained by an application for performing services related to transactions (e.g., performing calculations, processing payments, distributing funds to various sources, such as escrow accounts, and the like) are not generally under the control of or even visible to one or more parties to the transaction. Accordingly, embodiments of the present disclosure involve using self-executing programs (e.g., “smart contracts”) on modification-resistant hash chains (e.g., blockchains) to enable “auto-pilot” transactions, or transactions for which performance by the parties is automatically guided according to terms that are visible, immutable, and agreed to by all parties.

Hash chains are data structures that record data in a fashion analogous to a chain. Each update to the chain creates a new block containing the data and each block is linked to the previous block by a cryptographic function. Blocks are generally appended to the end of the chain and, once in the chain, resist modification so that the cryptographic links in the chain are preserved. Entities (e.g., applications) that receive data from blocks of the chain may check the cryptographic links to test the validity of the chain. Any modification of a block is detected and subject to remedial or other action. Hash chains are generally managed by peer-to-peer networks, which collectively adhere to an established protocol for validating each new block and are designed to be inherently resistant to modification of data. Once recorded, the data in any given block cannot be modified without the alteration of subsequent blocks and the involvement of the network.

As used herein, a “transaction” generally refers to an exchange of goods and/or services between parties, and generally comprises one or more terms agreed to by the parties. It is noted that a transaction may involve a “contract” between parties, and terms of the transaction may be agreed to by the parties as terms of the contract. However, the term “transaction” is generally used herein rather than “contract”. A “smart contract” generally refers to a self-executing program that implements one or more terms of a transaction and maintains state information.

Smart contracts are computerized transaction protocols that execute terms of a contract (e.g., for a transaction) through cryptographic code. When stored on a hash chain, smart contracts may be used to automatically guide performance of terms agreed to by parties while providing complete visibility and preventing modification to the terms (e.g., due to the transparent and modification-resistant properties of hash chains). Smart contracts may be automatically deployed based on transaction terms defined by one or more parties, such as through user interfaces. Furthermore, parties may be able to select existing smart contract templates that have been verified by trusted authorities for use in automatically guiding performance of a transaction. For example, a party may interact with a user interface to select an existing smart contract template from a database of verified smart contract templates. In some embodiments, smart contract templates may have variables (e.g., prices, addresses, and the like), which a party can define through a user interface when selecting a smart contract template. A smart contract generally performs a series of operations related to automatically guiding performance of one or more terms of a transaction. For example, the smart contract may automatically advance through stages of the transaction, prompt parties to perform actions, request and verify proofs that obligations have been met, verify identities of parties, and inform parties of the status of the transaction.

Terms of a transaction may be defined and confirmed by users through user interfaces described herein. For example, a user may define one or more terms of a transaction (e.g., price, shipment details, penalties for breach, and the like) through a user interface, and the terms may then be provided to other parties involved in the transaction for approval. Once all parties have agreed to terms of a transaction, one or more smart contracts corresponding to the terms are stored and deployed on a hash chain (or, in some cases, the smart contracts are selected from existing smart contracts on the hash chain). For example, a single smart contract may be deployed for each term of the transaction or a single smart contract may encompass multiple terms. Generally, terms that require different types of verification (e.g., payment and shipment) are included in separate smart contracts.

Techniques described herein provide improved transparency (e.g., because the contents of hash chains can be viewed by all parties), consistency (e.g., because smart contracts on hash chains are resistant to modification), trust (e.g., due to techniques for verifying that terms have been satisfied and for ensuring that terms have not been modified), and efficiency (e.g., due to the automation provided by embodiments of the present disclosure) in electronic execution of transactions.

### Example Computing Environment

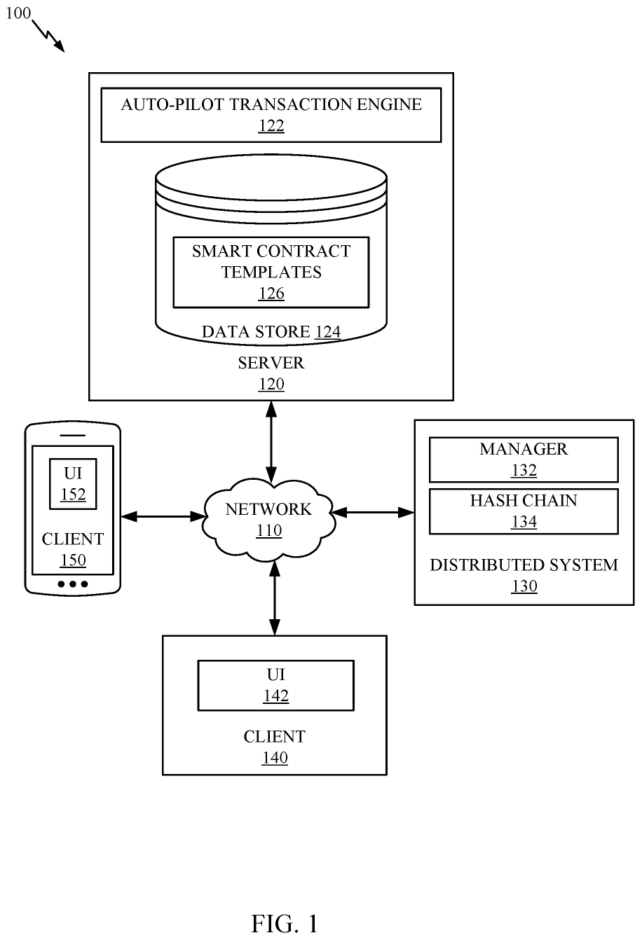

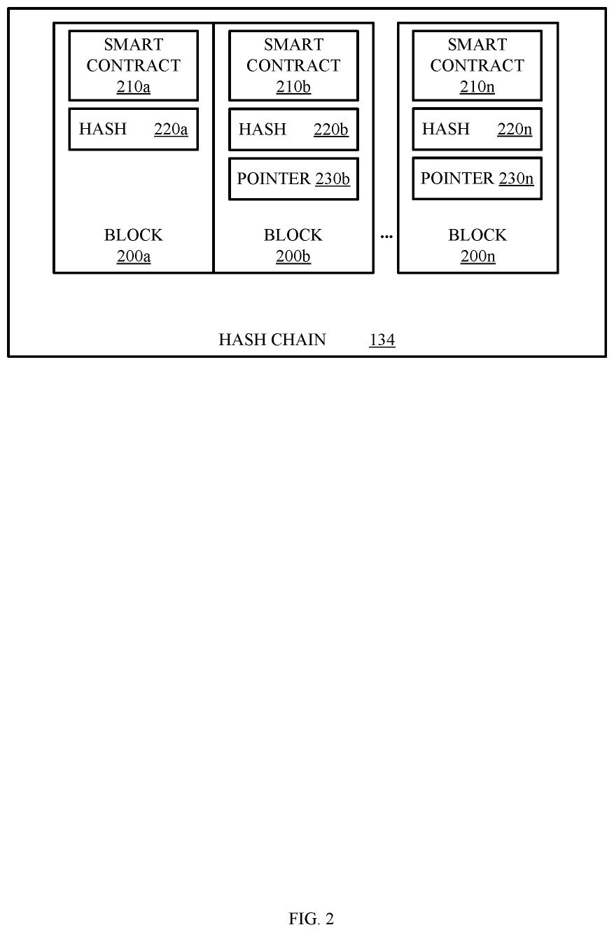

FIG. 1 illustrates an example computing environment 100 in which embodiments of the present disclosure may be implemented. FIG. 1 is described in conjunction with FIG. 2, which illustrates an example hash chain 134 on which embodiments of the present disclosure may be implemented.

Computing environment 100 includes a server 120 that communicates with a distributed system 130 and clients 140 and 150 over a network 110 in order to enable automatic guidance of transaction performance.

Server 120 is representative of a computing device, such as a rack server or desktop computer, which provides services to clients 140 and 150. Server 120 includes auto-pilot transaction engine 122, which performs operations related to automatically guiding performance of transactions. For instance, auto-pilot transaction engine 122 may be a server-side component of a client-server application that is accessed by users through user interfaces 142 and 152 of clients 140 and 150.

Server 120 further includes data store 124, which represents one or more data storage entities that store data related to auto-pilot transaction engine 122. In some embodiments, data store 124 stores user data for users of auto-pilot transaction engine 122 and data related to transactions, such as terms and mappings between terms and smart contracts stored on distributed system 130.

Distributed system 130 may comprise one or more physical or virtual computing devices, such as servers, desktop computers, laptop computers, portable electronic devices, or the like. Distributed system 130 comprises a manager 132 that performs management operations related to a hash chain 134. Manager 132 may, for example, receive and process requests to store, access, and execute data (e.g., smart contracts) maintained in hash chain 134 from outside entities (e.g., server 120 or clients 140 and 150). Manager 132 may provide data and notifications received from smart contracts deployed on hash chain 134 to external entities. In general, manager 132 serves as an interface between hash chain 134 and other entities on network 110.

Hash chain 134 is illustrated in additional detail in FIG. 2, which depicts a series of blocks 200a-n. It is noted that hash chain 134 may be independent of any particular computing device, and copies of all or portions of hash chain 134 may exist on a plurality of participant devices. Block 200a contains smart contract 210a and a hash 220a (e.g., a hash of smart contract 210a). Blocks 200b-n each comprise smart contract 210b-n, a hash 220b-n (e.g., hashes of smart contracts 210b-n), and a pointer 230b-n to the previous block. In another embodiment (not depicted), block 200a may have a pointer with a null value indicating that it is the first block in the hash chain.

Hashes 220 are generally determined (e.g., by manager 132) at the time each respective block 200 is added to the chain by applying a hash function to the smart contract 210 stored in the block 200. In some embodiments, hashes 220 may serve as identifiers for blocks 200. The integrity of hash chain 134 may be verified, such as for auditing purposes, by traversing the chain using pointers 230 and applying the hash function to the payload (e.g., smart contract 210) of each block 200 and comparing the result to the corresponding hash 220.

Each smart contract 210 may, for example, comprise a program that guides performance of one or more terms of a transaction. For instance, a smart contract 210 may be deployed by auto-pilot transaction engine 122, as described in more detail below, based on terms agreed to by parties to a transaction, and may automatically guide performance of the terms of the transaction by advancing through stages of the transaction, prompting users to perform actions, receiving proofs from users that actions have been completed, verifying proofs with trusted authorities, notifying users of updates in the transaction, and otherwise providing an “auto-pilot” experience for executing the terms of the transaction.

A block 200 storing a smart contract 210 may be added to hash chain 134 by manager 132 (e.g., at the request of auto-pilot transaction engine 122) according to an established protocol for appending new blocks to the chain, such as a consensus protocol or a trusted authority protocol. In certain embodiments, “miners” may be employed to ensure the integrity of modifications to the chain.

Returning to FIG. 1, Clients 140 and 150 represent computing devices associated with users (e.g., users of auto-pilot transaction engine 122). For example, clients 140 and 150 may comprise any form of electronic devices capable of running applications, receiving user input, providing output to users, and communicating data over a network interface. In one example, client 140 is a laptop or desktop computer and client 150 is a mobile device, such as a mobile phone or tablet. Clients 140 and 150 each comprise a user interface (UI) 142 and 152 through which users interact with auto-pilot transaction engine 122. UIs 142 and 152 may be substantially similar to each other. For example, a first party to a transaction may use client 140 to access auto-pilot transaction engine 122 through UI 142 and a second party to the transaction may use client 150 to access auto-pilot transaction engine 122 through UI 152.

In one example, a first user identifies a term of a transaction by interacting with UI 142 on client 140. UI 142 may display UI content received from auto-pilot transaction engine 122. For example, the first user may select a term type (e.g., price, shipment method, expected shipment date, or the like) from a list of term types listed in UI 142 and identify a value for the term type (e.g., a numerical value, a name of a postal carrier, a date, or another value) to define the term. In other embodiments, the first user selects the term from a list of existing terms that are associated with smart contracts and are displayed in UI 142. For example, there may be an existing smart contract on hash chain 134 that performs operations related to shipment via the United States Postal Service (USPS)®, such as prompting a user to ship a product, requesting proof of shipment (e.g., a confirmation number or tracking number), verifying the proof of shipment through interaction with USPS®, and notifying users of the status of shipment. This smart contract may be associated (e.g., in data store 124) with a term specifying that shipment is to be made through USPS®, and this term may be included in a list of terms displayed to the first user for selection via UI 142. In some embodiments, the smart contract has been verified by a trusted authority (e.g., the USPS® or other reliable users of auto-pilot transaction engine 122).

Once the first user identifies the term (or after the first user identifies all terms of a transaction), the term is provided to other parties involved in the transaction for confirmation. Parties to the transaction may be identified by the first user as part of the process for creating the transaction, such as within one or more terms, prior to identifying terms, or after identifying terms. For example, a second user (e.g., of client 150) may be another party to the transaction, and the second user may be presented with the term via UI 152 for review. The second user may propose a modification to the term, at which point it is returned to the first user for confirmation. Once all parties have confirmed the term (or all terms if there are multiple terms in the transaction), auto-pilot transaction engine 122 initiates deployment of a smart contract corresponding to the term(s) on hash chain 134. For example, auto-pilot transaction engine 122 may send a request to manager 132 to deploy the smart contract.

If the term identified by the first user does not already have a smart contract associated with it, a smart contract is deployed. For example, auto-pilot transaction engine 122 may deploy the smart contract based on the term by modifying one of smart contract templates 126 (e.g., associated with the term type, such as shipment terms or payment terms) based on user-provided values of the term (e.g., particular postal carriers, particular financial institutions, or particular trusted authorities). It is noted that most contracts will have a plurality of terms.

For instance, a smart contract template 126 for shipment terms may be generically configured to prompt a user to commence shipment, receive a proof of shipment, verify the proof of shipment with a variable postal carrier, and notify parties of shipment status. Auto-pilot transaction engine 122 may modify the smart contract template 126 by adding in information related to the specific postal carrier agreed to by the parties (e.g., a web address at which shipment can be verified through the postal carrier). In some embodiments, after the smart contract is generated for deployment based on the term agreed to by the parties, a summary of the smart contract is provided to the parties for review and approval. After generating the smart contract (and, in some embodiments, after receiving approval of the generated smart contract from the parties), auto-pilot transaction engine 122 may send the smart contract to manager 132 for deployment on hash chain 134. Manager 132 may use an established protocol to verify the smart contract and add a block (e.g., block 200n) to hash chain 134 including the smart contract (e.g., smart contract 210n), a hash of the smart contract (e.g., hash 220n), and a pointer to the previous block (e.g., pointer 230n).

It is noted that in some embodiments, one or more smart contracts may guide the process of prompting each party to review and approve terms of a transaction, keeping track of proposed changes from parties. As such, the one or more smart contracts may ensure that all parties agree to all terms of a transaction before the smart contract (or, in some cases, plurality of smart contracts) corresponding to the terms of the transaction is deployed.

Upon deployment, such as by request of auto-pilot transaction engine 122, the smart contract, which is a self-executing program, automatically performs operations related to the term. For example, the smart contract may push a notification through manager 132 to UI 142 informing the first user when it is time to ship a product, and may prompt the first user to provide proof of shipment. The first user may provide a tracking number for the shipment via UI 142, which is then provided to the smart contract (e.g., via manager 132). The smart contract may then verify the tracking number by automatically checking with the postal carrier to ensure that the product has been shipped. The smart contract may notify the second user that shipment has been confirmed, such as by pushing a notification to UI 152 via manager 132. The smart contract may continue to monitor the status of the shipment through the postal carrier based on the tracking number, notifying the parties of the status as appropriate. Once shipment is complete, the smart contract may prompt the second user to confirm that the shipment was received. If additional terms are included in the transaction, the smart contract may advance to operations related to a different term, or may initiate deployment of another smart contract. For instance, there may be a dependency chain between terms such that a first term must complete before a second term begins.

In one example, a payment term must be completed before a shipment term begins. For example, a smart contract for the payment term may verify with one or more financial institutions that payment is complete before initiating deployment of a smart contract for a shipment term. Other smart contracts may correspond to additional terms, such as related to returns and refunds, penalties for breach by one or more parties (e.g., failure to pay, failure to ship on time, etc.), and others.

In some embodiments each term is executed by a single smart contract, while in other embodiments a smart contract may execute multiple terms or an entire transaction. For example, using one smart contract per term may allow for efficient reuse of smart contracts stored on the hash chain, as a single term is more likely to be used again in the future than a specific set of terms. In some embodiments, smart contracts may verify identities of parties, such as by verifying personal information provided by users (e.g., names, birthdays, social security numbers, driver's license numbers, and other types of identifying information) with trusted authorities, such as governmental records. In certain embodiments, users agree to trusted authorities that are to be used to verify aspects of terms, such as though UIs 142 and 152.

If parties wish to modify a term of a transaction after deployment of a smart contract has begun, auto-pilot transaction engine 122 may cancel deployment of the smart contract through manager 132 and initiate deployment of a different smart contract corresponding to the modified term. Because blocks on hash chain 134 resist modification, changes to a term may require appending a new block to hash chain 134 corresponding to the changes. Modification of a term may generally require review and approval of all parties to ensure transparency and validity.

In general, each time a smart contract (or, in some embodiments, an individual term within a smart contract if there are multiple terms in a single smart contract) is deployed, a new block may be appended to hash chain 134 reflecting the results of deploying the smart contract. This allows auditing of transactions by traversing hash chain 134. Because the code of smart contracts and the results of deploying smart contracts are stored in a transparent and modification-resistant manner on hash chain 134, techniques described herein improve trust between parties to transactions. Furthermore, terms and corresponding smart contracts may be shared in a collaborative manner so that users can rely on previously verified smart contracts to efficiently and reliably execute terms of transactions.

Notably FIGS. 1 and 2 are depicted with a selected group of features for clarity and simplicity, but there may be additional elements of computing environment 100. Furthermore, certain functions described as being performed by server 120 may alternatively be performed by distributed system 130 or clients 130 or 140. In some embodiments, for example, auto-pilot transaction engine 122 is located on distributed system 130.

### Example User Interface

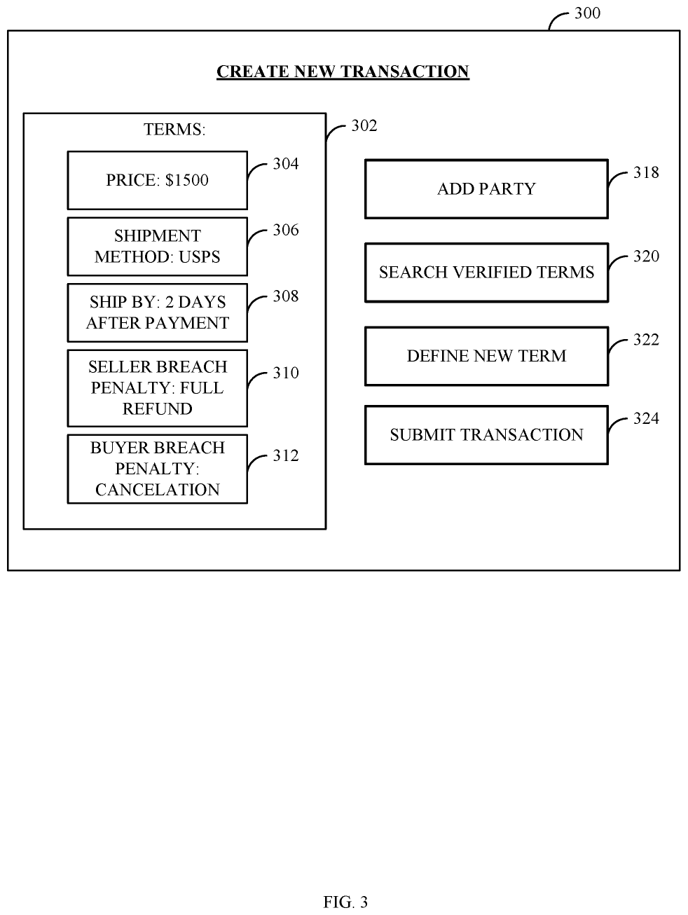

FIG. 3 depicts an example screen 300 of a user interface for automatically guiding performance of transactions. For example, screen 300 may be displayed in UI 142 or 152 of FIG. 1, and may be populated with content provided by auto-pilot transaction engine 122 of FIG. 1.

Screen 300 generally comprises a user interface screen for automatically guiding performance of transactions, particularly for defining terms of a new transaction. In certain embodiments (not shown), a user may define terms of a transaction as part of a larger user flow for generating an invoice or listing a product or service for sale.

Screen 300 includes terms 302 added by the user. For instance term 304 is a price term specifying a price of $1,500. Terms 306 and 308 are shipment terms specifying that the shipment carrier is USPS® and that shipment is to take place within 2 days after payment. Terms 310 and 312 are breach penalty terms specifying that the penalty for a breach by the seller is a full refund and penalty for a breach by the buyer is cancelation of the transaction. The user may have defined each of terms 302 by either searching verified terms using component 320 or defining new terms using component 322.

Component 318, when selected by a user, may launch a window that allows the user to add a party to the transaction. For example, the user may provide a name of the party along with other information, such as the party's email address, username within an application, date of birth, residential address, and/or the like. Component 318 may be used to add each party to the transaction, and the information provided by the user regarding each party, such as email addresses, may be used when sending terms to each party for review and approval.

Component 320, when selected by a user, may launch a window that allows the user to search existing terms that are associated with smart contracts that have been verified, such as by a trusted authority. A trusted authority may, for example, verify the validity of complex terms related to mediation, force majeure, and the like, as well as terms involving specific entities or organizations such as governmental agencies (e.g., terms for verifying shipping with the USPS®). For example, the user may search for or navigate to a verified “price” term that is associated with a smart contract for prompting a user to submit payment of a given price (e.g., through a particular method, such as using a credit card number or electronic check) and then verifying that payment of the price is complete, such as through interacting with one or more financial institutions associated with one or both parties

Component 322, when selected by the user, may launch a window that allows the user to define a new term. In some embodiments, the window allows the user to select from existing term types, such as payment terms, shipment terms, breach penalty terms, and others which may or may not be verified by trusted authorities. The user then enters one or more values related to the new term. For example, the user may select a term type of shipment terms, and then enter information related to USPS®, such as a web address at which shipment can be verified and tracked for USPS®. If the user defines a new term via component 322, the user may be provided with the option to send the term to a trusted authority (e.g., USPS®) for verification, and the term may then be stored in the database of verified terms for future use.

Once the user has finished adding terms for the transaction, component 324 allows the user to submit the transaction for confirmation by other parties. For example, when component 324 is selected, terms 302 may be provided to other parties involved in the transaction for review, such as via email addresses provided by the user when the parties were added via component 318.

Terms 302 are only included as examples, and other types of terms may be defined. For example, complex transactions may be defined with terms such as profit-sharing agreements between different entities, terms for initiating legal or arbitration processes, waiver agreements, severability provisions, notice provisions, force majeure provisions, escrow agreements, warranties, indemnity provisions, confidentiality provisions, and others.

Once all parties have agreed to terms 302, one or more smart contracts corresponding to terms 302 are deployed (e.g., by one or more processors) on a hash chain in order to automatically guide performance of the transaction. Each of terms 302 is mapped to a smart contract that is deployed on the hash chain, whether newly generated or generated based on a smart contract template. In certain examples, a smart contract is deployed for each given term and deployed on the hash chain. For instance, mappings between terms 302 and smart contracts (e.g., indicated by identifiers or addresses by which the smart contracts may be located on the hash chain) may be stored in data store 124 of FIG. 1 and used to deploy the smart contracts corresponding to terms 302.

In certain embodiments, a single smart contract may be deployed for the transaction, and the single smart contract may deploy other smart contracts corresponding to individual terms. For example, the single smart contract may ensure that dependencies between terms are satisfied before initiating deployment of separate smart contracts for the terms. As such, the single smart contract may control automatic guidance of performance of the entire transaction while relying on separate (e.g., previously existing and verified) smart contracts for individual terms.

### Example Method for Automatically Guiding Performance of Transactions

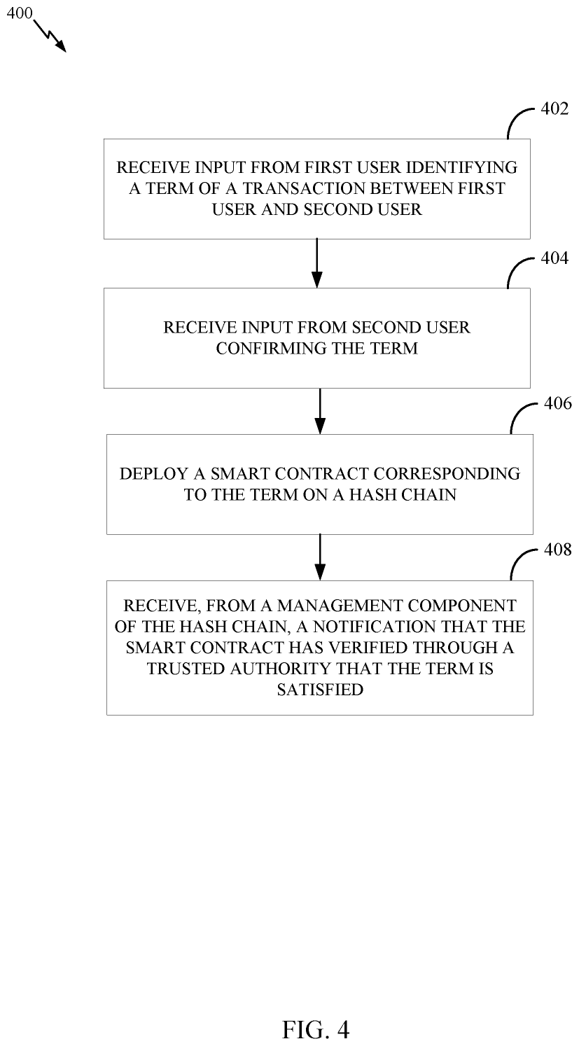

FIG. 4 depicts example operations 400 for automatically guiding performance of transactions. For example, operations 400 may be performed by one or more components of computing environment 100 of FIG. 1, such as auto-pilot transaction engine 122.

At step 402, input is received from a first user identifying a term of a transaction between the first user and a second user. For example, the first user may interact with UI 142 of FIG. 1 to define a new term or select an existing term for the transaction, such as a price or shipment term. In certain embodiments, the input also identifies information related to a trusted authority for verifying data related to the term.

At step 404 input is received from the second user confirming the term. For instance, the second user may be provided with the term for review via UI 152 of FIG. 1, and may confirm the term. In some embodiments a smart contract template corresponding to the term already exists (e.g., in a set of existing verified smart contract templates), and is used to deploy a smart contract corresponding to the term, while in other embodiments a smart contract corresponding to the term (or the entire transaction) is created without the use of a smart contract template.

At step 406, a smart contract corresponding to the term is deployed (e.g., by one or more processors) on a hash chain. For example, in embodiments where each term of a transaction corresponds to a separate smart contract, a mapping between the term and the smart contract may be stored in data store 124 of FIG. 1, and may be used to locate and deploy the smart contract on the hash chain, such as through submitting a request to a management component of the hash chain (e.g., manager 132 of FIG. 1). The smart contract generally performs operations related to automatically guiding performance of the term, such as by advancing through stages, prompting users to perform actions, receiving and verifying proofs, and notifying users of status updates. In certain embodiments, the smart contract may initiate deployment of separate smart contracts, such as to perform sub-tasks related to the term (e.g., verification tasks) or to initiate operations related to a next term in the transaction.

At step 408, a notification is received from a management component of the hash chain indicating that the smart contract has verified through a trusted authority that the term is satisfied. For example, the smart contract may receive a proof related to the term from a user, and may verify the proof through interaction with a trusted authority (e.g., identified at step 402). Upon successful verification of the proof, the smart contract may push a notification to auto-pilot transaction engine 122 of FIG. 1 indicating that the term has been satisfied. The first user and/or the second user may then be notified that the term is satisfied. In some embodiments, upon receiving the notification, auto-pilot transaction engine 122 of FIG. 1 may initiate deployment of another smart contract corresponding to another term. In other embodiments, the smart contract itself initiates deployment of another smart contract or continues with additional operations upon verifying the proof.

In some embodiments (not depicted), the first user or the second user may propose a modification to the term, and the proposed modification may be provided to the other user for confirmation. If both users agree to a modified term, an alternative smart contract may be deployed on the hash chain that corresponds to the modified term.

In some examples, an apparatus, including a memory comprising executable instructions and a processor in data communication with the memory and configured to execute the executable instructions, may be configured to cause the apparatus to perform a method for automatically guiding performance of transactions, such as method 400 (or any combination of the steps described above with respect to method 400).

In some examples, a non-transitory computer-readable medium comprising instructions that when executed by a processor of an apparatus cause the apparatus to perform a method for automatically guiding performance of transactions, such as method 400 (or any combination of the steps described above with respect to method 400).

### Example Computing Systems

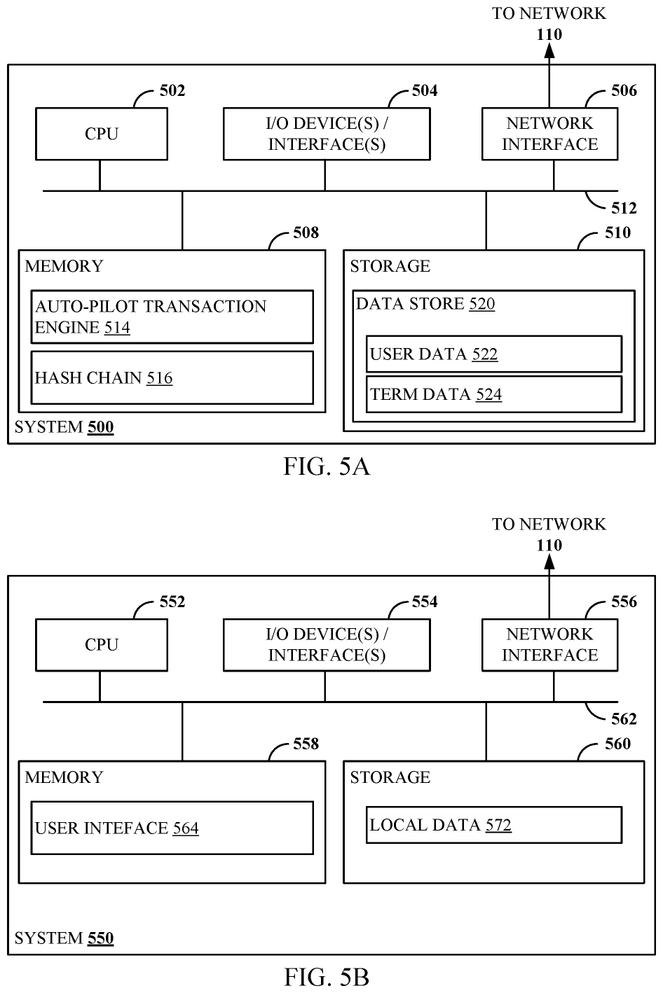

FIGS. 5A and 5B illustrate an example systems 500 and 550 used for automatically guiding performance of transactions.

System 500 may generally represent server 120 and/or one or more components of distributed system 130 of FIG. 1. System 500 includes a central processing unit (CPU) 502, one or more I/O device interfaces 504 that may allow for the connection of various I/O devices 504 (e.g., keyboards, displays, mouse devices, pen input, etc.) to the system 500, network interface 506, a memory 508, storage 510, and an interconnect 512. It is contemplated that one or more components of system 500 may be located remotely and accessed via a network. It is further contemplated that one or more components of system 500 may comprise physical components or virtualized components.

CPU 502 may retrieve and execute programming instructions, such as represented by auto-pilot transaction engine 514, stored in the memory 508. Similarly, the CPU 502 may retrieve and store data related to execution of the instructions in the memory 508. The interconnect 512 transmits programming instructions and application data, among the CPU 502, I/O device interface 504, network interface 506, memory 508, and storage 510. CPU 502 is included to be representative of a single CPU, multiple CPUs, a single CPU having multiple processing cores, and other arrangements.

In one embodiment, memory 508 is a random access memory.

Storage 510 may be a disk drive, solid state drive, or a collection of storage devices distributed across multiple storage systems. Although shown as a single unit, the storage 510 may be a combination of fixed and/or removable storage devices, such as fixed disc drives, removable memory cards or optical storage, network attached storage (NAS), or a storage area-network (SAN).

Storage 510 comprises data store 520, which may be representative of data store 124 of FIG. 1. While data store 520 is depicted in local storage of system 500, it is noted that data store 520 may also be located remotely (e.g., at a location accessible over a network, such as the Internet). Data store 520 includes user data 522 (e.g., user account information for users of auto-pilot transaction engine 514, such as user credentials, preferences, profile data, and other data related to transactions) and term data 524 (e.g., information related to terms, such as verification information, term type information, and mappings between terms and smart contracts). It is noted that, in some embodiments (not depicted), data store 520 may also include hash chain 134 of FIG. 1.

As shown, memory 508 includes auto-pilot transaction engine 514, which may be representative of auto-pilot transaction engine 122 of FIG. 1. Memory 508 further includes hash chain 516, which may be representative of hash chain 134 of FIG. 1 (e.g., a hash chain may be stored in a distributed fashion on one or more local or remote computing devices, and hash chain 516 may represent a local copy of all or part of the hash chain stored on system 500). Auto-pilot transaction engine 514 and/or hash chain 516 may alternatively be located remotely, such as on distributed system 130 of FIG. 1.

System 550 may generally represent client 140 or client 150 of FIG. 1. System 550 includes a CPU 552, one or more I/O device interfaces 554 that may allow for the connection of various I/O devices 554 (e.g., keyboards, displays, mouse devices, pen input, etc.) to the system 550, network interface 556, a memory 558, storage 560, and an interconnect 562. It is contemplated that one or more components of system 550 may be located remotely and accessed via a network. It is further contemplated that one or more components of system 550 may comprise physical components or virtualized components.

CPU 552 may retrieve and execute programming instructions, such as represented by user interface 564, stored in the memory 558. Similarly, the CPU 552 may retrieve and store data related to execution of the instructions in the memory 558. The interconnect 562 transmits programming instructions and application data, among the CPU 552, I/O device interface 554, network interface 556, memory 558, and storage 560. CPU 552 is included to be representative of a single CPU, multiple CPUs, a single CPU having multiple processing cores, and other arrangements.

In one embodiment, memory 558 is a random access memory.

Storage 560 may be a disk drive, solid state drive, or a collection of storage devices distributed across multiple storage systems. Although shown as a single unit, the storage 560 may be a combination of fixed and/or removable storage devices, such as fixed disc drives, removable memory cards or optical storage, network attached storage (NAS), or a storage area-network (SAN).

Storage 560 comprises local data 572, which may be representative of data related to user interface 564, such as user preferences, temporary files, and the like.

As shown, memory 558 includes user interface 564, which may be representative of user interface 142 or 152 of FIG. 1.

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for automatically guiding transaction performance, comprising:
receiving first input from a first user identifying a term of a transaction between the first user and a second user;
receiving second input from the second user confirming the term;
deploying a smart contract that corresponds to the term on a hash chain, wherein:
the smart contract comprises a program that guides performance of the term, and
the hash chain is resistant to modification; and
receiving, from a management component of the hash chain, a notification that the smart contract has verified through a trusted authority that the term is satisfied.

2. The method of claim 1, wherein the first input identifies the trusted authority, wherein the second input confirms the trusted authority, and wherein the method further comprises:
deploying the smart contract based on the term and the trusted authority; and
storing the smart contract on the hash chain.

3. The method of claim 1, further comprising: selecting a smart contract template from a plurality of smart contract templates on the hash chain based on the first input.

4. The method of claim 3, further comprising: determining that the smart contract template is verified by a third party.

5. The method of claim 1, further comprising:
receiving third input from the first user comprising a modified term of the transaction;
receiving fourth input from the second user confirming the modified term; and
deploying an alternative smart contract on the hash chain that corresponds to the modified term.

6. The method of claim 1, wherein receiving the first input from the first user comprises displaying a plurality of terms to the first user via a user interface and receiving a selection by the first user of the term from the plurality of terms.

7. The method of claim 1, further comprising: notifying the first user and the second user that the transaction is complete based on the notification.

8. A non-transitory computer-readable medium comprising instructions that, when executed by one or more processors, cause the one or more processors to perform a method for automatically guiding transaction performance, the method comprising:
receiving first input from a first user identifying a term of a transaction between the first user and a second user;
receiving second input from the second user confirming the term;
deploying a smart contract that corresponds to the term on a hash chain, wherein:
the smart contract comprises a program that guides performance of the term, and
the hash chain is resistant to modification; and
receiving, from a management component of the hash chain, a notification that the smart contract has verified through a trusted authority that the term is satisfied.

9. The non-transitory computer-readable medium of claim 8, wherein the first input identifies the trusted authority, wherein the second input confirms the trusted authority, and wherein the method further comprises:
deploying the smart contract based on the term and the trusted authority; and
storing the smart contract on the hash chain.

10. The non-transitory computer-readable medium of claim 8, wherein the method further comprises: selecting a smart contract template from a plurality of smart contract templates on the hash chain based on the first input.

11. The non-transitory computer-readable medium of claim 10, wherein the method further comprises: determining that the smart contract template is verified by a third party.

12. The non-transitory computer-readable medium of claim 8, wherein the method further comprises:
receiving third input from the first user comprising a modified term of the transaction;
receiving fourth input from the second user confirming the modified term; and
deploying an alternative smart contract on the hash chain that corresponds to the modified term.

13. The non-transitory computer-readable medium of claim 8, wherein receiving the first input from the first user comprises displaying a plurality of terms to the first user via a user interface and receiving a selection by the first user of the term from the plurality of terms.

14. The non-transitory computer-readable medium of claim 8, wherein the method further comprises: notifying the first user and the second user that the transaction is complete based on the notification.

15. A system, comprising one or more processors and a non-transitory computer-readable medium comprising instructions that, when executed by the one or more processors, cause the one or more processors to perform a method for automatically guiding transaction performance, the method comprising:
receiving first input from a first user identifying a term of a transaction between the first user and a second user;
receiving second input from the second user confirming the term;
deploying a smart contract that corresponds to the term on a hash chain, wherein:
the smart contract comprises a program that guides performance of the term, and
the hash chain is resistant to modification; and
receiving, from a management component of the hash chain, a notification that the smart contract has verified through a trusted authority that the term is satisfied.

16. The system of claim 15, wherein the first input identifies the trusted authority, wherein the second input confirms the trusted authority, and wherein the method further comprises:
deploying the smart contract based on the term and the trusted authority; and
storing the smart contract on the hash chain.

17. The system of claim 15, wherein the method further comprises: selecting a smart contract template from a plurality of smart contract templates on the hash chain based on the first input.

18. The system of claim 17, wherein the method further comprises: determining that the smart contract template is verified by a third party.

19. The system of claim 15, wherein the method further comprises:
receiving third input from the first user comprising a modified term of the transaction;
receiving fourth input from the second user confirming the modified term; and
deploying an alternative smart contract on the hash chain that corresponds to the modified term.

20. The system of claim 15, wherein receiving the first input from the first user comprises displaying a plurality of terms to the first user via a user interface and receiving a selection by the first user of the term from the plurality of terms.
